(19) United States
(12) Patent Application Publication
(10) Pub. No.: US 2018/0236881 A1
(43) Pub. Date: Aug. 23, 2018

(54) AXLE CARRIER FOR THE DISPOSAL ON AN ELECTRIC MOTOR VEHICLE, AND METHOD FOR THE PRODUCTION OF SAID AXLE CARRIER

(71) Applicant: Benteler Automobiltechnik GmbH, Paderborn (DE)

(72) Inventors: Volker GRIENITZ, Soest (DE); Hermann OPDEMOM, Beckum (DE); Matthias KOERNER, Bielefeld (DE); Frank RABE, Hiddenhausen (DE)

(21) Appl. No.: 15/901,849

(22) Filed: Feb. 21, 2018

(30) Foreign Application Priority Data
Feb. 22, 2017 (DE) 10 2017 103 663.6

(51) Int. Cl. B60L 11/18; B62D 21/03; B62D 29/04; B62D 29/00; H01F 27/28; H01F 27/02; H01F 41/04

(52) U.S. Cl. CPC B60L 11/182; B62D 21/03; B62D 29/041; B62D 29/005; H01F 41/04; H01F 27/02; H01F 27/2876; H01F 27/2885; H01F 27/2823

(57) ABSTRACT

An axle carrier for an electric motor vehicle and a method of manufacturing thereof is disclosed. The axle carrier has a shell component including an upper shell and a lower shell made from a fiber-composite material, and at least one induction line is integrated in the lower shell.

### RELATED APPLICATIONS

The present application claims the priority of German Application Number 10 2017 103 663.6, filed Feb. 22, 2017, the disclosure of which is hereby incorporated by reference herein in its entirety.

### BACKGROUND

### 1. Field of the Invention

The disclosure is generally related to an axle carrier and a method of manufacturing thereof and, more specifically, to an axle carrier for an electric motor vehicle.

### 2. Description of the Related Art

It is known in the prior art for motor vehicles to be driven by carbon-containing energy carriers. To this end, internal combustion engines which convert the chemical energy present in the fuel to kinetic energy while absorbing oxygen and discharging heat and combustion gases.

The fuel carried along in the motor vehicle and utilized by the internal combustion engine can be resupplied to the motor vehicle when required at a fueling station, the operational availability of the motor vehicle being established for a respective range.

Vehicles having an internal combustion engine are increasingly being replaced by electrically driven motor vehicles because of environmental and economical requirements of reducing the demand for carbon-containing energy carriers and of reducing the discharge of combustion gases. The energy required for propulsion herein is stored in batteries, also referred to as electrical accumulators, respectively, or accumulator batteries, respectively, in the motor vehicle per se. To this end, battery carriers or battery trays are in most instances disposed in particular in the underfloor region of the motor vehicle in order for the batteries which to some extent have a large mass and a large space requirement to be received. For the purpose of charging the batteries, the motor vehicle by way of a plug-in electrical line is connected to an external electricity generator such that an electrical amperage can cause a change in the electrical charges in each of the connected electrical batteries.

It is further known from the prior art that the accumulator batteries of an electric motor vehicle can be charged in a non-contacting manner. To this end, the induction of an electrical voltage by means of a magnetic field that alternates in a temporal manner is utilized in order for the electrical energy to be transmitted in a non-contacting manner to the motor vehicle.

A respective induction conductor is provided to this end on or in the motor vehicle, the induction conductor being able to be supplied with electrical energy from a charging station in a non-contacting manner by means of induction.

A front-axle carrier which is produced in a shell construction is known from DE 10 2014 112 090 A1.

A sheathing of a secondary coil which is disposed below a structural element of the vehicle is further known from WO 2016/096067 A1.

### SUMMARY

It is the object of the disclosure to integrate an induction conductor which forms at least one electrical induction loop in the region of the front axle.

According to one exemplary embodiment, an axle carrier is configured as a front-axle carrier for an electric motor vehicle. The axle carrier can also be referred to as an axle sub-frame. The axle carrier has a shell configuration having an upper shell and a lower shell, wherein at least the lower shell is made from a fiber-composite material. The axle carrier is distinguished in that at least one induction line is integrated in the lower shell. Additionally, the lower shell from a fiber-composite material can comprise one or a plurality of magnetizable bodies which are disposed within the induction loop that is formed by the induction line.

The production of the lower shell from a fiber-composite material thus enables an induction line and, particularly, an induction loop to be at least partially or completely enclosed. A separate component can thus be dispensed with. Tight space conditions in the region of the axle carrier, in particular of the front-axle carrier, can be compensated for in that the induction loop is integrated in the axle carrier already during the production process of the latter. The induction line in the axle carrier can thus be provided across a large region in terms of area, so as to enable an efficient non-contacting transmission of energy from the exciter apparatus of an inductive charging station on the ground.

An organic sheet which is coupled to the lower shell in particular in a materially integral manner is furthermore particularly preferably disposed on one side of the lower shell. The side on which the organic sheet is disposed is in particular the lower side of the lower shell. The organic sheet is a flat product produced from a fiber-composite material. This protects the lower shell and the induction line located therein from stone-chipping, weather influences, and furthermore serves as an underside protection.

The upper shell may be a component formed from a metallic material, for example from a steel alloy or an aluminum alloy. The upper shell and the lower shell are preferably intercoupled by way of a form-fit and/or a materially integral fit. The upper shell and the lower shell are preferably adhesively bonded to one another and optionally additionally riveted and/or screwed. A ribbed structure which stiffens the two shells can be provided between the upper shell and the lower shell. The ribs may be integrally produced so as to be materially integral to the lower shell and can optionally be joined to the upper shell. The ribs can also be produced separately and coupled to the lower shell and subsequently be likewise coupled to the upper shell.

In particular, the induction line and presently an earth lead of the induction line can be connected to the metallic upper shell. The metallic upper shell is connected to a body of the electric motor vehicle. The complexity in terms of electrical lines or connectors can be reduced on account thereof.

The fiber-composite material of the lower shell and presently in particular a part, in particular the complete fiber-composite material, may be produced from an electrically non-conducting fibrous material and/or matrix resin.

The lower shell can in particular be produced from fiber-composite material in an injection-molding method. The induction herein, in particular in the case of an induction loop, can be embedded in the fibrous material and in the matrix resin of the fiber-composite material. Any shearing of fibers, in particular also any severing from the matrix resin, is precluded in the production procedure. The induction line is thus in particular completely embedded or enclosed, respectively, in the lower shell.

However, the lower shell can also be produced as an impact-extrusion component, for example. This production method is expedient in particular when the induction line is produced as a flat or planar body and in particular from one or a plurality of tiers of a metal sheet. The induction line in this case can be punched and/or cut from a metal sheet.

In the case of the induction line not being configured as a flat or planar body, the lower shell can likewise be produced in the impact-extrusion method. To this end, two half-shells are particularly preferably produced, wherein the induction line is then incorporated between the half-shells and the half-shells are inter-coupled, in particular by materially integral adhesive bonding. To this end, at least one half-shell, particularly preferably on an internal side, consequently on that side that is directed toward the other half-shell, has a clearance, for example a groove. This clearance can then be provided for receiving the induction line.

The induction line is in particular a wire-shaped or tubular conductor from an endless material, which in particular is configured from an electrically conducting material, preferably having a specific electrical conductivity [symbol] of at least 10 ·10⁶ 1/(Ωm) at T=293 Kelvin, the material being alumina, copper, nickel, or alloys thereof, for example. The induction line is in particular configured as an induction loop. The induction line can also be produced from one or a plurality of tiers of a metal sheet. The induction line in this case is punched or cut, respectively, from the metal sheet.

The current path resulting from the induction line is in particular longer than the shortest spacing between the electric terminals at which the electrical voltage is received from the induction line.

It is furthermore advantageously provided that the induction loop is applied to the lower shell and is in particular wound on to the latter. The induction line is then subsequently covered or sheathed with an isolation layer. The isolation layer per se is in particular produced from the matrix material of the fiber-composite material.

In one further advantageous variant of design embodiment the lower shell per se is configured in multiple tiers. At least one tier is produced from the fiber-composite material, and one second tier is produced from a metallic material, wherein the two tiers are inter-coupled in particular in a materially integral manner. The tier from metallic material can in particular be the induction line per se. The multiple-tier lower shell is then coupled to the upper shell.

At least one tier of fiber-composite material is furthermore advantageously configured so as to be electrically non-conducting. A tier from electrically conducting material for the induction line, or else an induction line from endless material is coupled to the former. A shielding tier from fiber-composite material is furthermore disposed on that side that is opposite the electrically non-conducting tier. The induction line would thus be disposed between an electrically non-conducting tier and a shielding tier. The shielding tier is in particular configured at least partially from electrically conducting fibrous material. The shielding tier is in particular decoupled from the induction line such that an electrical isolation is configured, for example by electrically non-conducting matrix resin, between the induction line and the shielding tier.

According to some embodiments, a method of method of manufacturing the axle carrier from a fibrous-material blank is disclosed. The fibrous-material blank is produced by a wrapping procedure, alternatively also by a weaving procedure. The induction line herein is wrapped or woven, respectively, into the fibrous-material blank. The fibrous material blank thus produced is impregnated with matrix resin after and/or during the wrapping procedure and optionally subjected to a subsequent forming procedure.

The induction line may be completely embedded in the fiber-composite material. Preferably, the induction line can effectively be placed into the fibrous material blank across a freely selectable region of the area.

### BRIEF DESCRIPTION OF THE DRAWINGS

For an understanding of embodiments of the disclosure, reference is now made to the following description taken in conjunction with the accompanying drawings, in which:

FIG. 1 is a perspective view of an axle carrier assembly in accordance with an exemplary embodiment;

FIG. 2 is a sectional view of the axle carrier of FIG. 1 taken along the line B-B;

FIG. 3 is a longitudinal sectional view of the lower shell of FIG. 1 taken along line B-B;

FIG. 4 is a longitudinal sectional view of FIG. 3 with two parallel induction lines disposed on top of one another; and,

FIGS. 5 to 16 are plan views of various forms of induction lines.

In the figures, the same reference signs are used for identical or similar components, even if a repeated description is dispensed with for reasons of simplicity.

### DETAILED DESCRIPTION OF SOME EMBODIMENTS

Some embodiments will be now described with reference to the Figures.

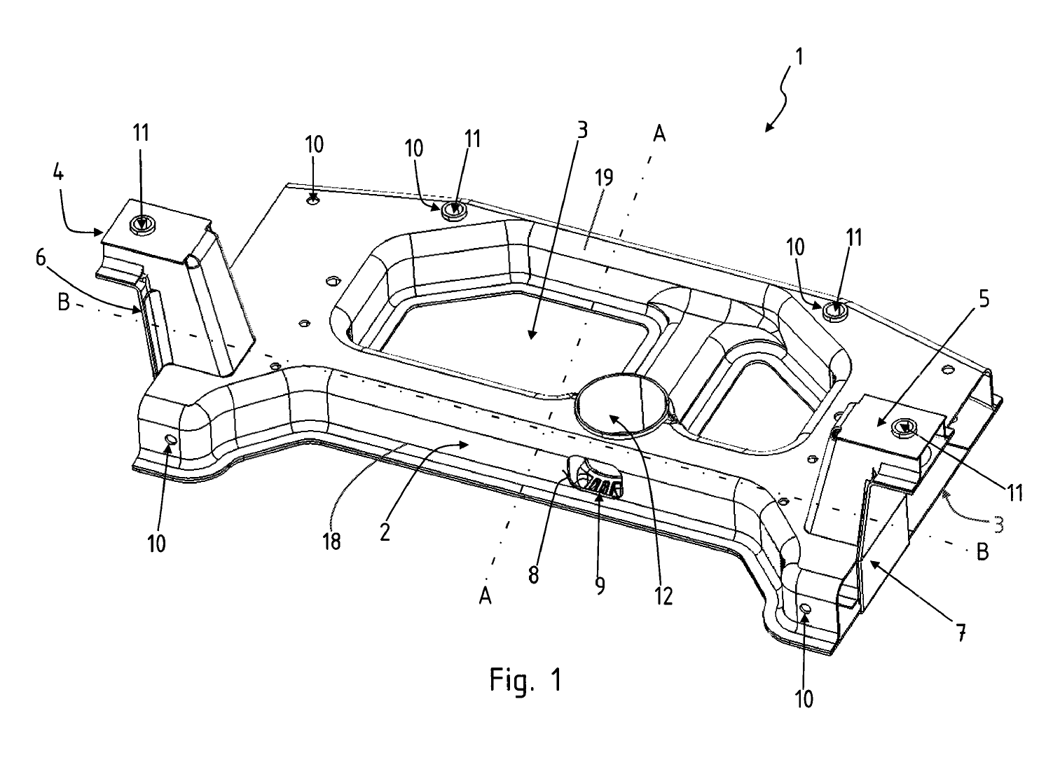

Referring to FIG. 1, an axle carrier 1 is shown. The axle carrier 1 comprises an upper shell 2, a lower shell 3, and a ribbed structure having reinforcing ribs 9 for stiffening the upper shell 2. The reinforcing ribs 9 in FIG. 1 can be seen only through the opening 8 since the reinforcing ribs 9 otherwise are located completely in the cavity 23 of the axle carrier 1. The upper shell 2 in this exemplary embodiment is produced from a fiber-composite material. The lower shell 3 is composed of a fiber-reinforced plastics, wherein the fiber reinforcement preferably includes both long fibers as well as short fibers. The reinforcing ribs 9 are conjointly configured in an integral manner to the lower shell 3 and are composed of a short fiber-reinforced plastics. The fibers herein have a length of up to 10 cm.

Two attachment towers 4, 5 are attached to the upper shell 2. The attachment towers 4, 5 serve for attaching the axle carrier 1 to the vehicle body. Stiffening portions 6, 7 which protrude into the attachment towers 4, 5 are optionally configured from the lower shell 3. The lower shell 3 is configured as a planar face without clearances and closes off the lower shell 2 across the full area from below. The lower shell 3 can also be configured in an analogous manner to that of the upper shell 2, having longitudinal supports and transverse supports 18, 19. The stiffening portions 6, 7 are angled upward in relation to the planar plane of the lower shell 3, thus so as to point toward the upper shell 2, and in turn terminate the attachment towers 4, 5. Other attachment locations 10 for other suspension parts such as, for example, a stabilizer or control arm, are likewise partially provided with attachment sleeves 11 for reinforcement.

The bearing 12 represents a further attachment location of a particular configuration. The bearing 12 serves for attaching a torque support of the drive unit and thus for supporting the torques of the drive unit.

On account of the upper shell 2 being produced according to the invention from fiber-composite material, the attachment towers 4, 5 can be conjointly integrally configured in a materially integral manner. The various attachment locations 10 and/or attachment sleeves 11 can likewise be conjointly cast in the fiber-composite material. The upper shell 2 can have mutually dissimilar wall thicknesses which in particular corresponds to the strength that is in each case predefined in regions.

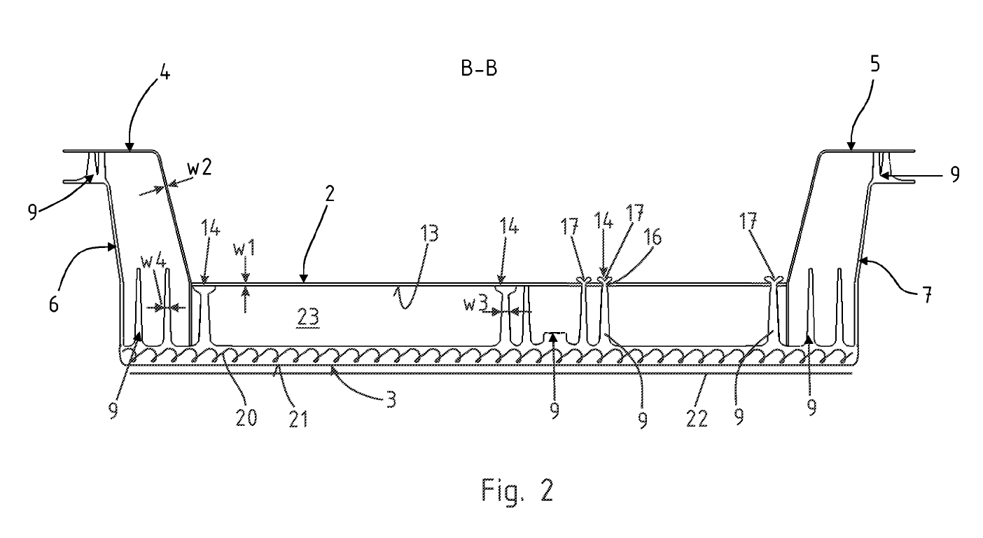

FIG. 2 shows a longitudinal section according to the section line B-B of FIG. 1. The reinforcing ribs 9 which in particular at least partially bear on an internal side 13 of the upper shell 2 can be readily seen. An upper end 14 of the reinforcing ribs herein is widened according to the invention, in particular according to the principle of a mushroom head. This is illustrated on the left side in relation to the image plane. First, an upper end 14 of the reinforcing rib 9 is heated, as illustrated by thermal rays 15. The heat can be applied by means of hot air, for example. The reinforcing rib 9 is thereafter pressed onto the internal side 13 of the upper shell 2. The upper end 14 widens according to the principle of a mushroom head. A larger bearing face is thus provided, but at the same time a materially integral connection is also generated.

Furthermore, mutually dissimilar wall thicknesses W1 and W2 are illustrated in an exemplary manner here on the upper shell 2. The wall thicknesses W1 and W2 of the upper shell 2 and the lower shell 3 can in regions be dimensioned according to the respective stresses. The wall thicknesses W3, W4 of individual reinforcing ribs 9 can also be dissimilar.

Alternatively or additionally, it is also possible for the upper end 14 of the reinforcing rib 9 to be provided with a V-shaped gap 17 or wedge, respectively, and for the latter here to be likewise fused by thermal rays 15 by way of hot air, for example. On account thereof, a V-shaped splitting of the upper end 14 of the reinforcing rib 9 is supported when the latter is being pressed on.

FIG. 2 illustrates, on the right side in relation to the image plane, that the upper end 14 of the respective reinforcing rib 9 engages through a clearance 16 of the upper shell 2 and in particular configures an undercut in the manner of a mushroom head. An additional form-fitting coupling is provided on account thereof. This can also be combined with the widening of the upper end 14 on the internal side 13.

According to the invention it is now provided that an induction line 20 is integrated in the lower shell 3. The induction line 20 is disposed in particular in the region of a lower side 21. An organic sheet 22 can preferably be furthermore disposed below the lower shell 3 and optionally be coupled to the latter. The coupling of the organic sheet 22 and the lower shell 3 herein is also performed in particular in a materially integral manner.

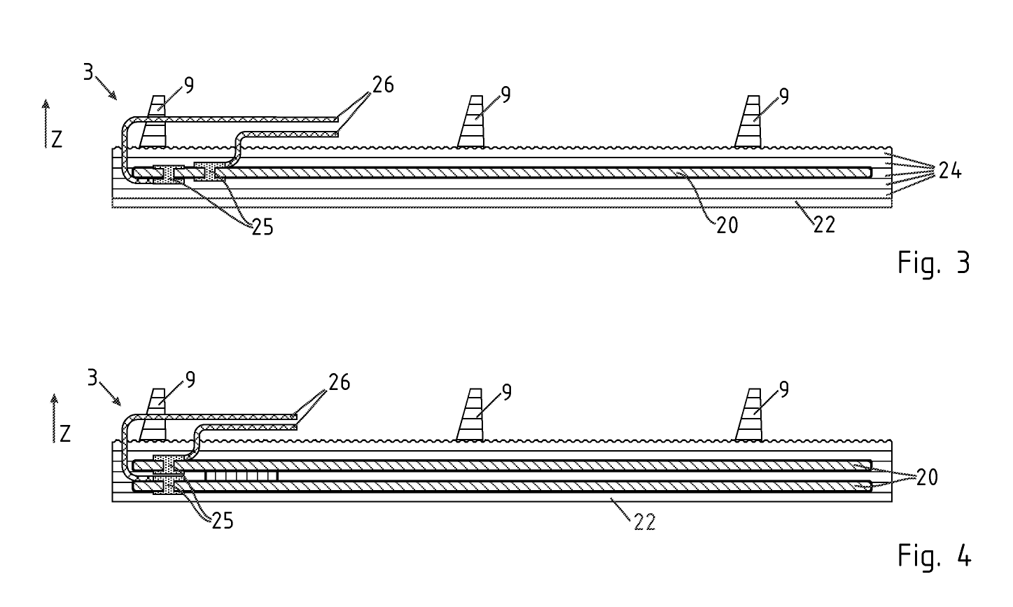

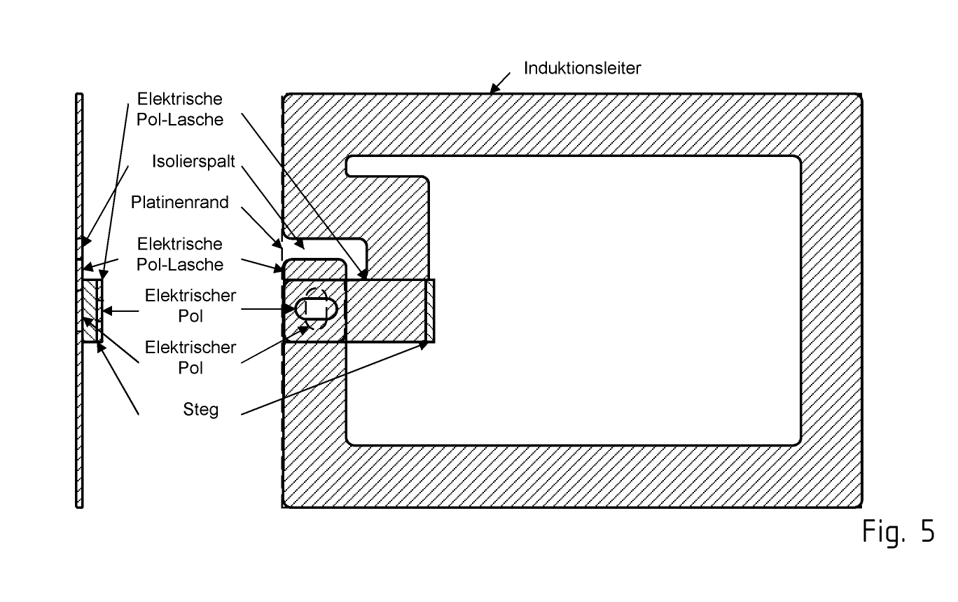

FIG. 3 shows a longitudinal sectional view through the lower shell 3 produced according to the invention, according to the section line B-B from FIG. 1. Various tiers of fibrous material 24 herein are disposed on top of one another, wherein a lowermost tier is configured as an organic sheet 22, for example. The other fibrous material tiers 24 can be produced from a laminated fiber-composite material or else from organic sheets 22 which are adhesively bonded to one another. The induction line 20 is embedded or enclosed, respectively, therein. The induction line 20 has electric terminals 25 on one side, the electric terminals 25 being illustrated again in FIG. 5 and the following figures and by way of electrical connector lines 26 being connected, for example, to a charging management unit (not illustrated in more detail).

FIG. 4 shows a longitudinal sectional view in a manner analogous to that of FIG. 3, with the difference that two parallel induction lines 20 are disposed on top of one another in the motor vehicle vertical direction. The two induction lines 20 overall preferably result in an induction line which accordingly enables non-contacting charging.

FIGS. 5 to 16 show various views of potential induction lines 20, therein referred to as induction conductors, in each case in a plan view.

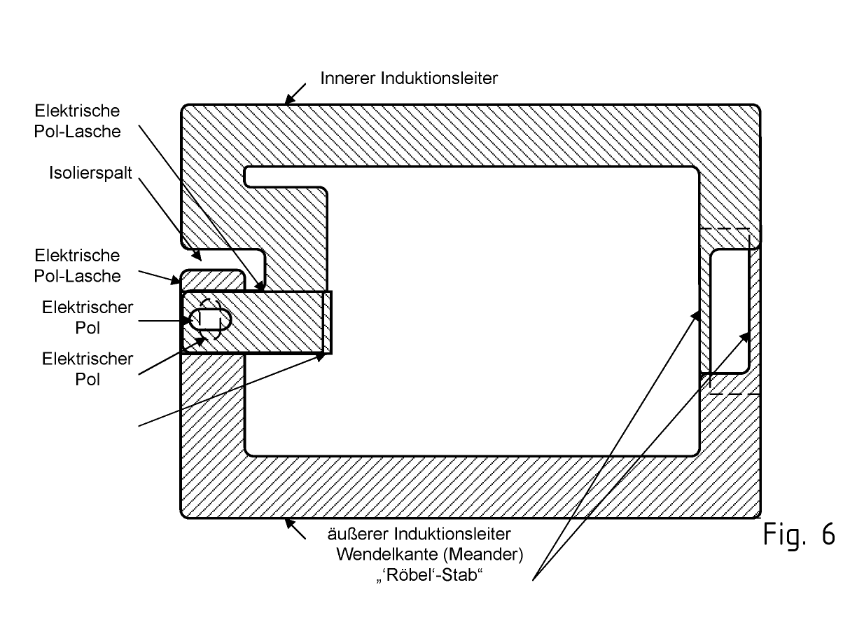

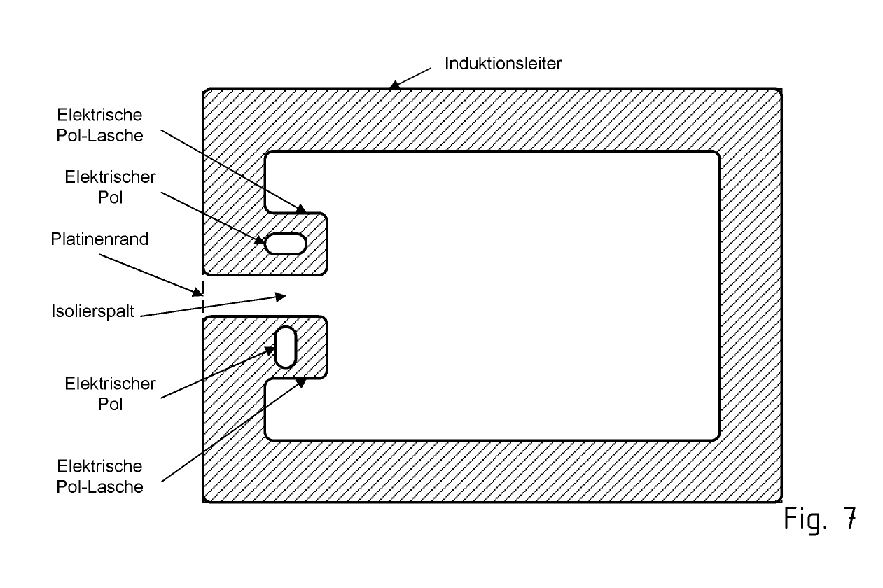

FIG. 5 herein shows a plan view and a side view of an induction conductor which as a punch-folded piece is folded from a metal sheet or from a metal foil. The same applies to FIG. 6.

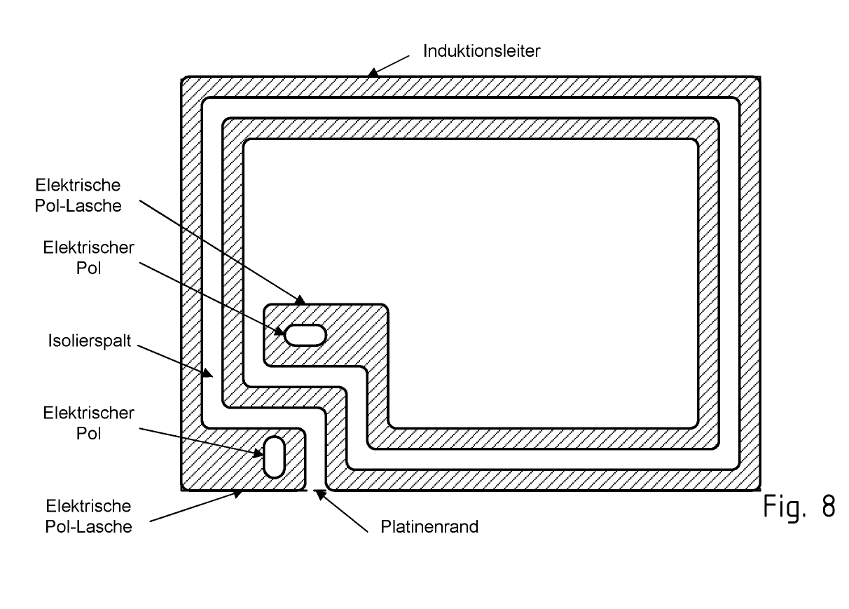

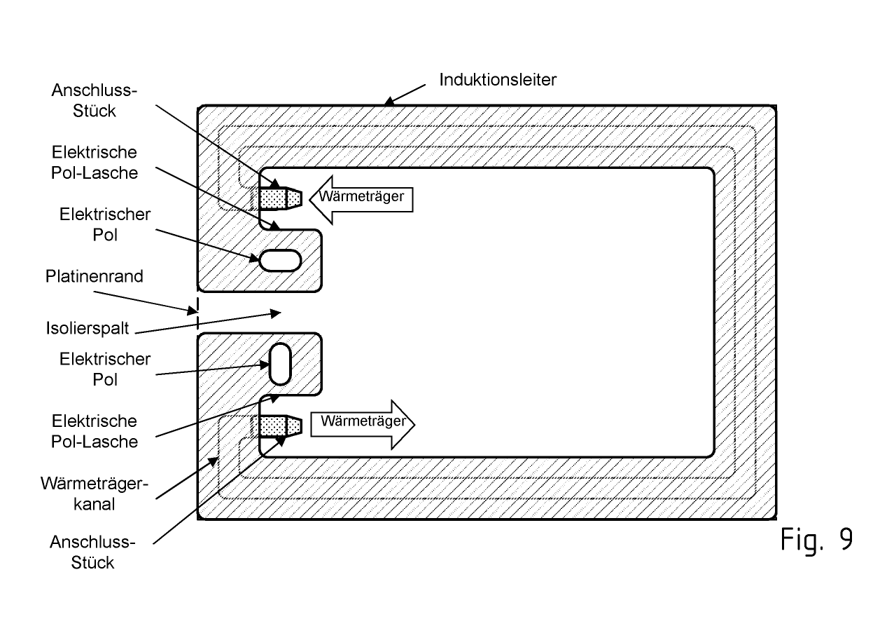

FIG. 7 and FIG. 8 show in each case induction conductors which as punched pieces are cut from a metal sheet. The induction conductor according to FIG. 8 in particular is wound multiple times.

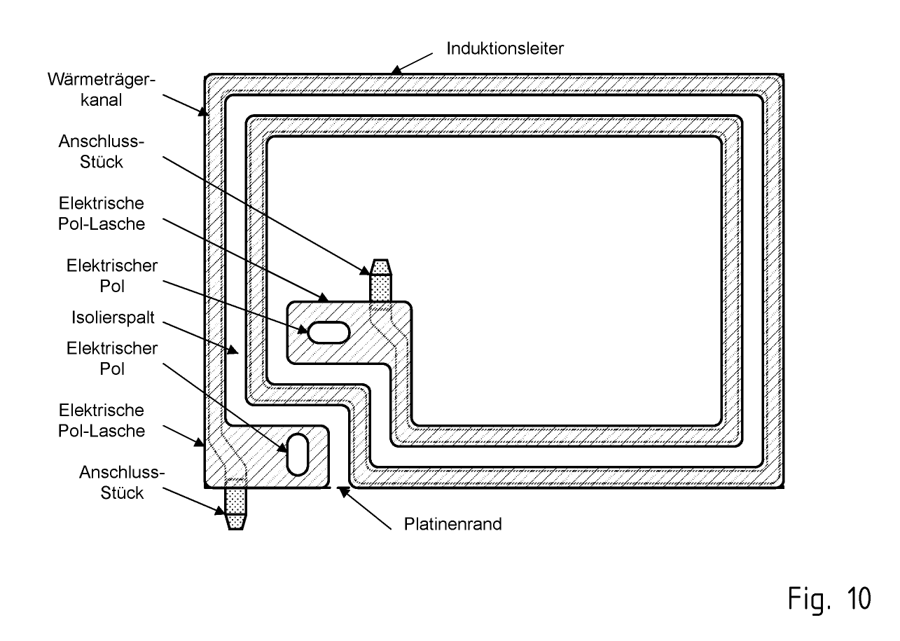

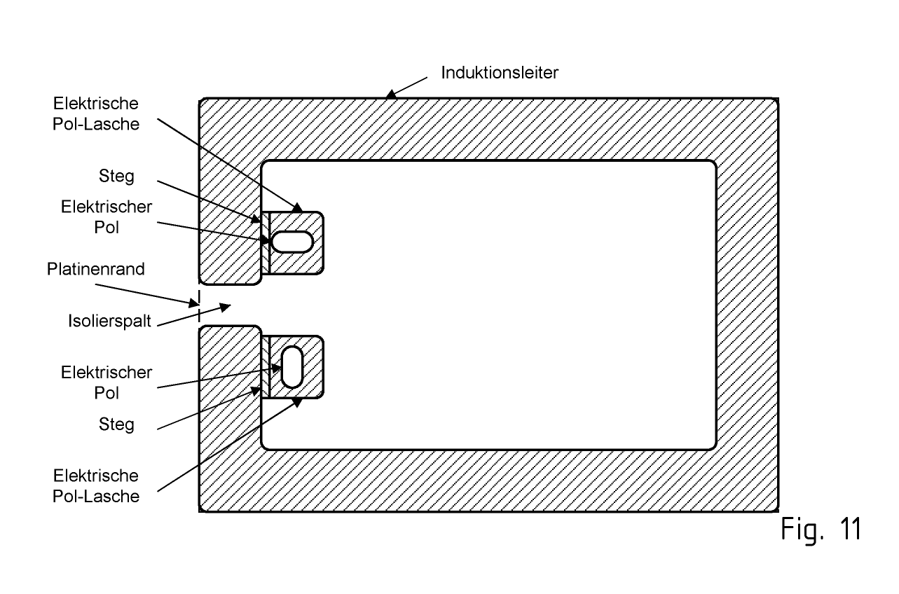

FIGS. 9 and 10 show an induction conductor that as a joint-punched piece is produced from a double metal sheet. A thermal medium duct is also integrated in the induction conductor here such that a thermal medium in particular for cooling can be routed through by way of connector pieces. These thermal medial ducts in this instance are likewise incorporated conjointly with the induction conductor in the fiber-composite material

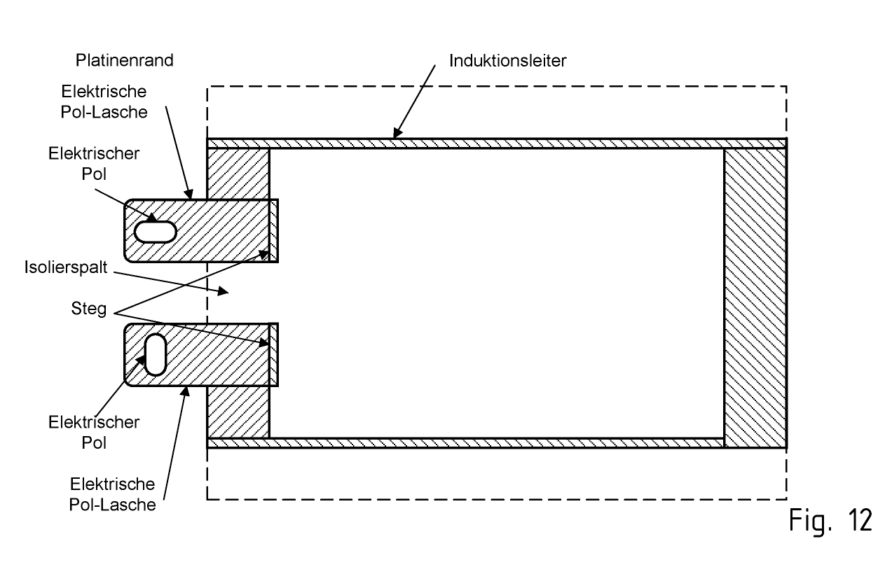

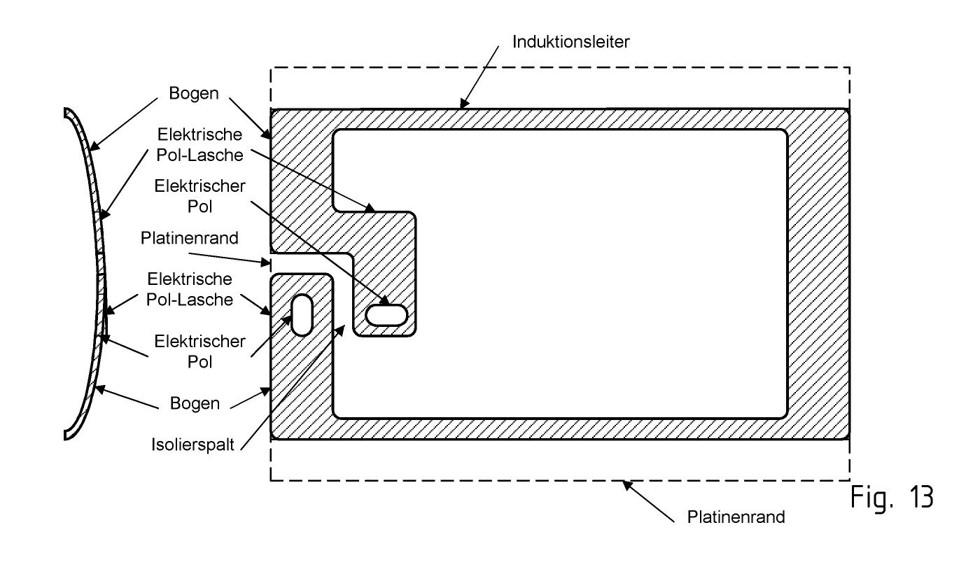

FIGS. 11 and 12 show in each case an induction conductor as a punched edge-bent piece which is punched from a metal sheet and is subsequently edge-bent.

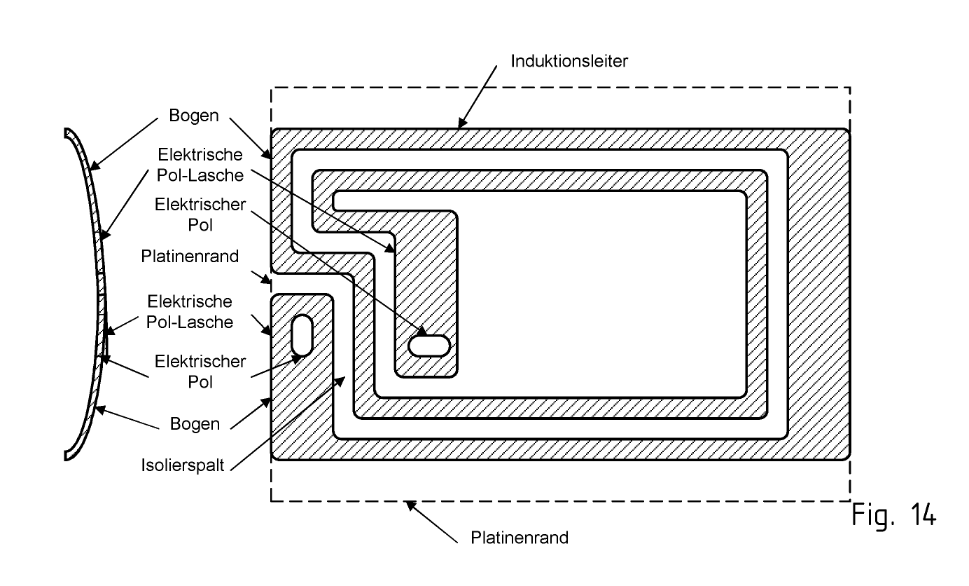

FIGS. 13 and 14 show in each case an induction conductor that is bent from a punched bent piece from a metal sheet in the plan view and a side view. It can be seen that the induction conductor has a curved or arcuate, respectively, cross-sectional profile.

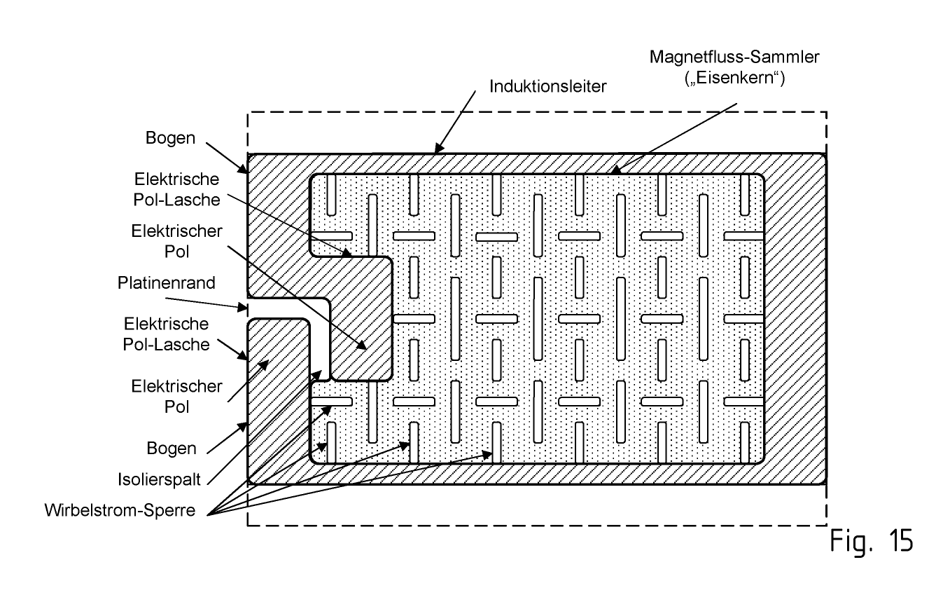

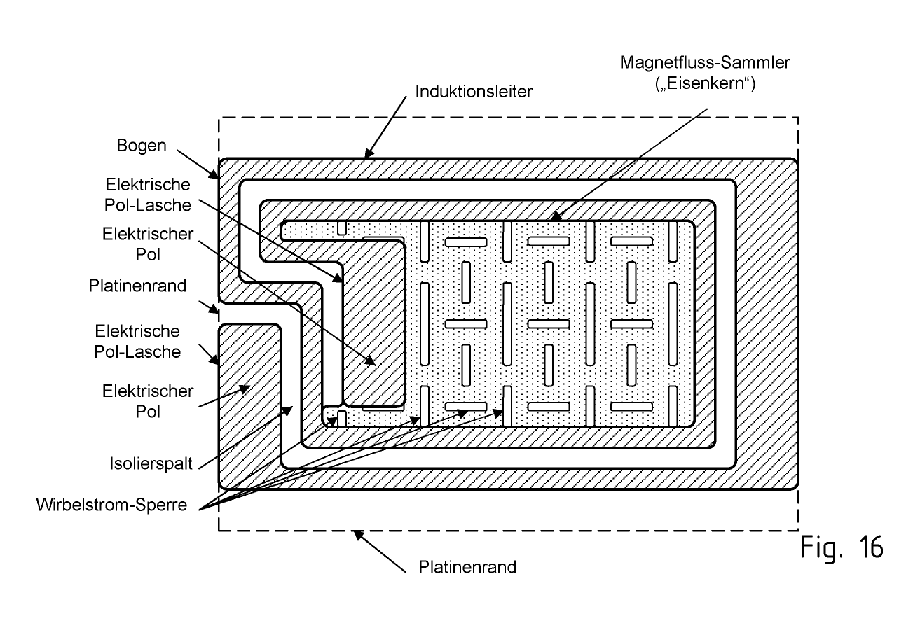

FIGS. 15 and 16 show in each case an induction conductor which as a punched piece is cut from a metal sheet. A magnetic flux collector, in particular an iron core, is disposed in the internal region. The entire induction conductor having the iron core in turn is incorporated in the fiber-composite material.

The foregoing description of some embodiments of the invention has been presented for purposes of illustration and description. It is not intended to be exhaustive or to limit the invention to the precise form disclosed, and modifications and variations are possible in light of the above teachings or may be acquired from practice of the invention. The specifically described embodiments explain the principles and practical applications to enable one ordinarily skilled in the art to utilize various embodiments and with various modifications as are suited to the particular use contemplated. It is intended that the scope of the invention be defined by the claims appended hereto, and their equivalents. Further, it should be understood that various changes, substitutions and alterations can be made hereto without departing from the spirit and scope of the invention as described by the appended claims.

1-15. (canceled)

16. An axle carrier for an electric motor vehicle, comprising:
an upper shell;
a lower shell attached to the upper shell and made from a fiber-composite material; and,
at least one induction line integrated in the lower shell.

17. The axle carrier of claim 16, further comprising an organic sheet coupled to the lower shell on a lower side and/or wherein the upper shell is configured from a metallic material.

18. The axle carrier of claim 16, wherein the induction line is embedded in the fiber-composite material and/or an earth lead of the induction line is coupled to the metallic upper shell.

19. The axle carrier of claim 16, wherein the lower shell is produced from fiber composite material by injection-molding, or from electrically non-conducting fiber-composite material, or from a fiber-composite material of electrically isolating fibers.

20. The axle carrier of claim 16, further comprising a ribbed structure comprising a plurality of ribs and disposed between the lower shell and the upper shell, wherein the ribs are produced conjointly with the lower shell and are joined to the upper shell.

21. The axle carrier of claim 20, wherein the lower shell is an impact-extrusion component, wherein the induction line is produced as a flat or planar body or from a metal sheet.

22. The axle carrier of claim 21, wherein the lower shell comprises two half-shells produced in the impact-extruding method, wherein the induction line is incorporated between the two half-shells, and wherein at least one of the two half-shells includes a clearance for receiving the induction line on the internal side thereof.

23. The axle carrier of claim 16, wherein the induction line is made from a wire-shaped or tubular conductor of an endless material as an induction loop, or in that the induction line is produced from one or from a plurality of tiers of a metal sheet.

24. The axle carrier of claim 23, wherein the induction line surrounds or wraps at least partially at least one body from a ferro-magnetic or ferritic material.

25. The axle carrier of claim 24, further comprising a current path that results from the sheet metal and is longer than the shortest spacing between the electric terminals at which the electricity that is induced in the induction line is received from the induction line.

26. The axle carrier of claim 16, wherein the induction line is wound onto the lower shell and covered with an isolation layer, wherein the isolation layer is configured from the matrix material.

27. The axle carrier of claim 26, wherein the induction line is at least partially subjected to a circulating or incident flow by a fluid thermal medium.

28. The axle carrier of claim 16, wherein lower shell comprises multiple tiers, wherein at least one tier is a fiber-composite material, and a second tier is a metallic material, wherein the two tiers are integrally coupled to one another.

29. The axle carrier of claim 28, wherein at least one tier from a fiber-composite material is configured so as to be electrically non-conducting, a shielding tier from a fiber-composite material which has an electrically conducting fibrous material being disposed on that side that is opposite the electrically non-conducting tier.

30. A method of manufacturing the axle carrier of claim 16, comprising:
producing a fibrous material blank by a wrapping method,
wrapping the induction line in the fibrous material blank,
impregnating the fibrous material blank with matrix resin after and/or during the wrapping method.
